(19) United States
(12) Patent Application Publication
(10) Pub. No.: US 2022/0266947 A1
(43) Pub. Date: Aug. 25, 2022

(54) DRIVE DEVICE, AND VEHICLE

(71) Applicant: Günter LANG, Wernau (DE)

(72) Inventor: Günter LANG, Wernau (DE)

(21) Appl. No.: 17/620,503

(22) PCT Filed: Jun. 15, 2020
(86) PCT No.: PCT/EP2020/066510

§ 371 Date: Dec. 17, 2021

(30) Foreign Application Priority Data
Jun. 18, 2019 (DE) 10 2019 116 458.3

(51) Int. Cl. B62M 6/60; B62M 6/75

(52) U.S. Cl. CPC B62M 6/60; B62M 6/75

(57) ABSTRACT

The drive assembly according to the invention for vehicles comprises a motor support which is mounted movably on the vehicle and which has an electric motor which is connected drivingly to a driving gear. A drive wheel is assigned to the wheel of the vehicle and, for example, is designed as a ring arranged concentrically to the rotation axis of the wheel. The driving gear and the drive wheel are connected to one another drivingly via a traction means, for example a closed toothed belt, a closed chain, a closed band, or the like. The motor support has at least one support wheel, preferably a plurality of support wheels, and optionally a support roller, via which the motor support runs similarly to a rail vehicle on the annular drive wheel. The radial position of the motor support in relation to the rotation axis of the wheel and also the axial position (towards and away from the wheel) are determined by the cooperation of the support wheels and corresponding tracks and optionally a running surface of the drive wheel. The drive assembly described in this regard is particularly smooth-running in this regard, easily accessible, and insensitive to fouling.

### CROSS-REFERENCE TO RELATED APPLICATIONS

This application is a National Stage of PCT Application No. PCT/EP2020/066510 filed on Jun. 15, 2020, which claims priority to German Patent Application No. 10 2019 116 458.3 filed on Jun. 18, 2019 and entitled DRIVE DEVICE, AND VEHICLE, the contents each of which are incorporated herein by reference thereto.

### TECHNICAL FIELD

The invention refers to a drive device and a vehicle equipped with such a drive device.

### BACKGROUND

Vehicles, particularly bicycles with motor auxiliary drive, are basically known from the prior art. For example, FR 867489 discloses a bicycle, the rear wheel of which is connected to a ring attached to the spokes. An auxiliary drive having a friction wheel acts on this ring in order to transmit drive power to the rear wheel of the bicycle.

US RE 37583 E discloses a bicycle having an electrical auxiliary motor that acts upon a sprocket connected to the rear wheel. Thereby the motor is supported by a motor support that is rigidly screwed to the bicycle frame.

DE 44 04 518 A1 discloses an auxiliary drive for bicycles that is also electric motor driven. This auxiliary drive comprises an electric motor that acts on the tire of the front wheel of a bicycle by means of a friction wheel.

An electrical front drive of a bicycle is known from TW 2009 51021, wherein a sprocket is part thereof that is connected with a front wheel and on which the pinion of an electric motor acts.

WO 2012/03217 discloses, on the contrary, a bicycle having a rear wheel auxiliary drive, wherein a sprocket is part thereof connected with the spokes of the rear wheel. This sprocket comprises guiding tracks for rollers of a motor support unit that supports an electric motor. This electric motor comprises a drive pinion engaging the sprocket. The motor support is hinged to the bicycle frame, wherein the hinged joint only serves as torque support for the motor. The tracks and rollers of the sprocket and the motor support determine the orientation of the motor.

With this concept remarkable progress in terms of reliability and performance of the drive has been achieved. However, it has to be noted that the teeth of the sprocket can be subject to a certain contamination at least in off-road use.

U.S. Pat. No. 2,375,508 shows an auxiliary drive for a bicycle, wherein the auxiliary motor engages a sprocket via a pinion, wherein the sprocket has to be connected to the spokes of the bicycle. The sprocket comprises teeth projecting radially inward, whereby the tendency for contamination of the teeth is reduced.

DE 69730928 T2 uses, on the contrary, a belt drive for power transmission between a transmission motor and a wheel of a bicycle. For this a pulley is attached on the spokes of the driven wheel to which a tooth belt is assigned. It runs over the pinion of a transmission motor. The motor support is rigidly connected with and screwed to the bicycle frame in order to maintain the belt tensioned.

While the tooth wheel drive is characterized by low power losses and thus a high transmission efficiency, the typically high running smoothness has to be high-lighted in belt drives. However, the belt drive usually requires a high belt tension to ensure that the tooth belt does not skip in case of high drive powers, i.e. that the teeth of the tooth belt always remain in reliable engagement, particularly with the driving pinion. A high belt pretensioning, however, results in a remarkable bearing stress, in a spoke stress, as well as high precision requirements referring to the concentricity of the drive wheel connected with the spokes and also reduces the transmission efficiency.

It is therefore the object of the invention to provide a drive device that remedies at least one or also multiple of the drawbacks of the above-mentioned drive concepts.

### BRIEF SUMMARY

A drive arrangement for a human-powered two-wheeled vehicle, including: a wheel rotatably supported on the vehicle; a drive wheel that can be attached to the wheel; a traction means arranged in a manner embracing the drive wheel; a motor support that is hingedly joined to a frame part of vehicle; an electric motor attached to the motor support and being drivingly connected with a driving gear that is arranged in a manner being in engagement with traction means; and at least one support wheel that is rotatably supported relative to motor support and that is arranged in a rolling manner on the drive wheel.

The drive arrangement according to the present invention is for a vehicle, particularly a two-wheeled vehicle, such as, for example, a bicycle. The drive arrangement can, however, be realized with three-wheeled vehicles or multiple-wheeled vehicles, particularly four-wheeled vehicles. In doing so, one or multiple wheels of the respective vehicle can be provided with such a drive arrangement. Particularly, the inventive drive arrangement is suitable as auxiliary drive for human-powered vehicles.

The drive wheel that is to be connected with the wheel of the vehicle is part of the drive arrangement. The drive wheel can be, for example, a sprocket with radially outwardly extending teeth that can be brought into engagement with a suitable traction means, e.g. a chain or a tooth belt. The teeth of the sprocket or any other gear form the traction means engagement surface.

A traction means is in addition part of the drive arrangement, e.g. the already mentioned chain or tooth belt or, if desired, also frictionally driving traction means, as for example a non-toothed plastic or steel band. Independent from the specific configuration, any traction means is closed in a ring-shaped manner, wherein one complete revolution along the traction means defines the length thereof. Such a traction means is also denoted as “endless” traction means.

The drive arrangement further comprises a motor support on which at least one electric motor is held that is in turn drivingly connected with a driving gear. For this the driving gear can be directly connected with the drive shaft of the motor. Alternatively, a transmission, particularly a reduction gear, can be arranged between the driving gear and the driven shaft of the motor. The transmission can be configured to define a non-variable transmission ratio. Alternatively, the transmission can have changeable transmission ratios, i.e. “speeds”. Also a coupling can be provided between the electric motor and the driving gear in order to be able to connect and disconnect the driving connection between the motor and the driving gear. The coupling can be an overrunning clutch, a clutch, a toothed coupling, a friction coupling or the like.

The driving gear is adapted to the traction means in order to get into a driving engagement therewith. Hence, the drive wheel and the driving gear can be provided with a toothing respectively fitting with an assigned tooth belt, an assigned chain or the like. If the traction means is a non-profiled band, for example a steel band, the drive wheel and the driving gear can be configured as non-toothed rollers having a substantially cylindrical friction surface on their periphery that forms the traction means engagement surface.

Also part of the inventive drive arrangement is at least one support wheel that is rotatably supported relative to the motor support and arranged in a rolling manner on the drive wheel. The support wheel serves to support the motor support against the drive wheel. In doing so, the support wheel is particularly suitable to support a force that tensions the motor support towards the drive wheel. In addition, this concept ensures compliance with a suitable tension of the traction means that is constant apart from driving forces, which is particularly of importance, if the traction means shall comprise a certain constant pretension. If, for example, the driving gear is not absolutely centrically attached to the spokes of the wheel, the motor support follows the (slight) eccentricity of the driving gear without causing tension variations in the traction means thereby. This results in a smooth low resistance operation of the transmission formed by the driving gear, the traction means and the drive wheel. The at least one support wheel supports the belt tension on the drive wheel.

Preferably the diameter of the drive wheel, the length of the traction means and the diameter of the driving gear are adapted to one another such that the wrap angle β with which the traction means wraps around the drive wheel is larger than 300°. In doing so, the far longer part of the circumference of the drive wheel is covered by the traction means such that fouling of the contact surface between the drive wheel and the traction means, i.e. a fouling of the toothing in the case of tooth belts, is excluded to a great extent.

It has in addition turned out to be advantageous, if the length of the traction means is at most as long as the sum of the circumferences of the drive wheel and the driving gear. It is however expedient, if the length of the traction means is longer than the minimum length required for embracing of driving gear and drive wheel. It is particularly expedient to push the traction means by means of at least one guide wheel, preferably two guide wheels, against the driving gear in order to increase the wrap angle on the driving gear compared with a freely tensioned traction means. Due to this measure, a suitable traction means, e.g. a chain or particularly a tooth belt, can be guided with low or without pretensioning in order to minimize friction and fulling losses and on the other hand, however, to avoid skipping of the tooth belt on the driving gear. In addition, covering of teeth of the driving gear and the drive wheel by means of the tooth belt is increased to the extent that in practical operation no disturbing fouling of the toothings is possible. The guide wheels can be adjustably arranged on the motor support in order to be able to adjust the traction means pretensioning.

The at least one support wheel is preferably freely rotatably supported on the motor support. Thereby it can be freely rotatably supported coaxially to the driving gear on the motor shaft or on separate bearing supports.

In a preferred embodiment at least one track for the at least one support wheel is formed on the drive wheel. Multiple of such tracks can be formed on the drive wheel as well. These tracks can be arranged on both sides of the toothing or any other traction means engagement surface provided for engagement with the traction means. Thereby the track can have a diameter different from the traction means engagement surface. Preferably, the track is a cylinder surface. In doing so, a smooth running operation of the motor support is allowed on the drive wheel. The tracks serve as radius for the support wheels.

Further details of advantageous embodiments of the invention are apparent from the claims as well as the following description of embodiments according to the invention.

### BRIEF DESCRIPTION OF THE DRAWINGS

In the drawings embodiments of the invention are illustrated. The drawings show:

FIG. 1 a bicycle having an electric auxiliary drive in schematic side view,

FIG. 2 the electric auxiliary drive illustrated in part in a schematic view,

FIG. 3 a torque support of the auxiliary drive in a separate illustration in part,

FIG. 4 a front view of the auxiliary drive in part in a sectional illustration,

FIG. 5 a modified embodiment of the inventive drive in a schematic illustration,

FIG. 6 another modified embodiment of the inventive drive arrangement in top view and

FIG. 7 the drive arrangement according to FIG. 6 in a sectional front view in a simplified illustration.

### DETAILED DESCRIPTION

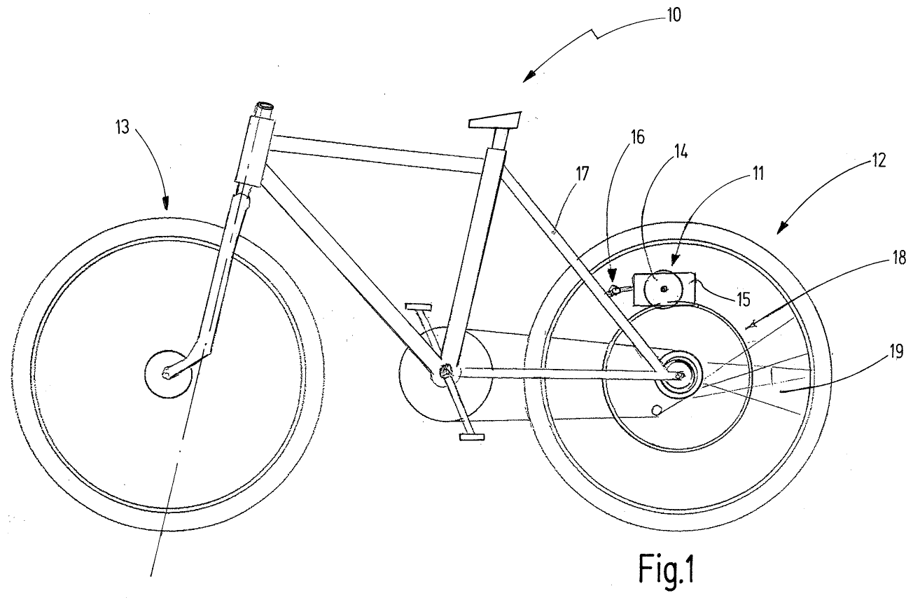

A bicycle 10 is illustrated in FIG. 1 to which reference is made only by way of example for illustration of the invention. The bicycle can be a children's bike, a youths' bike, a bike for adults, a cargo bike, a tracking bike, a touring bike, an off-road bike or also any arbitrary bike having one, two or multiple seats. Also the invention described in the following can be realized with other vehicles, e.g. a scooter, a rickshaw, a bicycle trailer or with other vehicles with or without additional human-powered drive.

A drive arrangement 11 is attached to the bicycle 10 that is here serving for driving the rear wheel 12 of the bicycle 10. Alternatively or additionally, such a drive arrangement 11 can also be attached to the front wheel 13 of bicycle 10 or another vehicle.

The drive arrangement 11 comprises an electric motor 14 that is mounted on a motor support 15 or the housing of which itself is configured as such a motor support. The motor support 15 is joined in a hinged manner by means of a hinged joint 16 to a frame strut 17 of bicycle 10. The hinged joint 16 serves particularly for supporting the drive torque created by the motor support 15, i.e. for support of the drive counter torque. Preferably the hinged joint 16 comprises a hinge that allows an upward and downward movement of the motor support 15 as well as at least a certain pivot movement toward wheel 12 and away therefrom. At least to a small extent the hinged joint can also allow a pivot movement of the motor support 15 around an axis lying longitudinally relative to the connection and lying tangentially to the drive wheel 18. In this case the hinged joint 16 exclusively forms the torque support for the motor support.

A drive wheel 18 is part of the drive arrangement that is preferably configured as ring that is connected, e.g. screwed, with spokes 19 of wheel 12. Another configuration and attachment of the drive wheel 18 is however possible. The ring-shaped drive wheel 18 is thereby preferably attached to the spokes 19 of wheel 12 in a manner centered to the extent that it rotates without substantial eccentricity. However, smaller eccentricities of, for example, 1 mm are largely innocuous. The motor support 15 follows such an eccentricity with a respective pivot movement. For this purpose FIG. 3 illustrates the hinged joint 16 in part in sectional illustration. As apparent, a hinge is configured between two struts 20, 21, comprising an eyelet 22 through the opening of which a bolt 23 extends illustrated in FIG. 3 in section. Thereby the bolt is preferably orientated parallel to the rotation axis of the rear wheel 12.

The eyelet 22 is preferably provided with a ring groove extending along the wall of its opening in which a damping and buffer element 24, e.g. in the form of an O-ring, is held. This buffer element 24 damps shocks and vibrations and remarkably contributes to the smoothness of the drive arrangement 11. In addition, cylindrical bolt 23 is preferably longer than the eyelet such that eyelet 22 can be displaced along bolt 23 and thus parallel to the rotation axis of wheel 12. The eyelet 22 is pivotable in all three pivot degrees of freedom, at least slightly in each case.

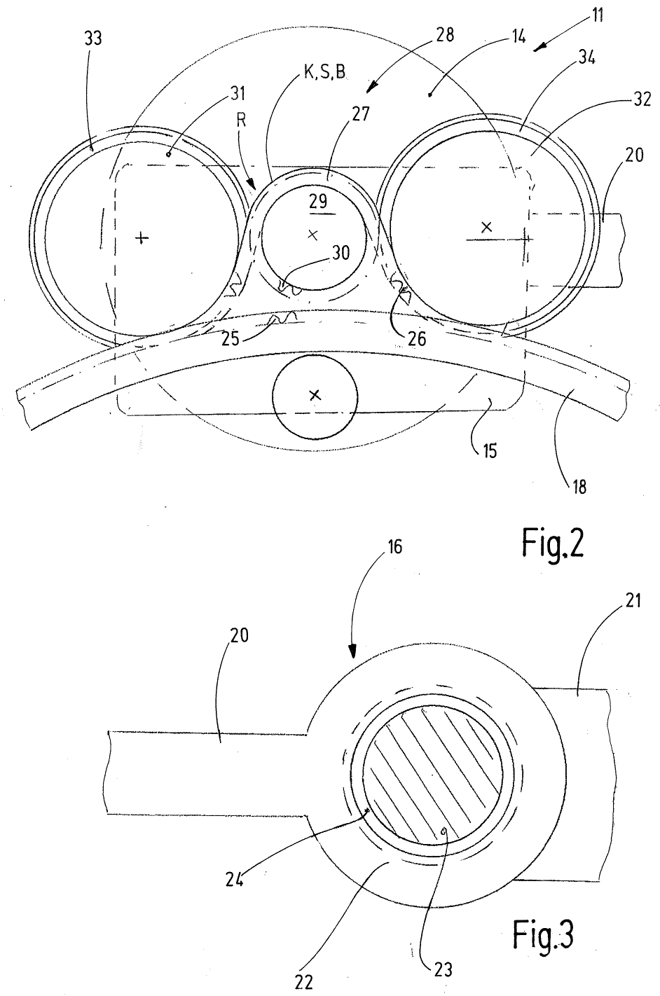

The drive arrangement is further illustrated in FIG. 2. As apparent drive wheel 18 is configured as externally toothed ring, the toothing 25 of which fits with toothing 26 of a traction means 28 configured as tooth belt 27. The toothing forms the traction means engagement surface. The tooth belt 27 is guided over a driving gear 29 that is directly connected with the driven shaft of the electric motor 14 in the present embodiment. However, if required also a transmission, particularly reduction gear, an overrunning clutch or any other coupling can be arranged between the driven shaft of the electric motor and the driving gear 29. The driving gear 29 comprises a toothing 30 that fits with toothing 26 of tooth belt 27.

Also at least one, preferably two guide wheels 31, 32 are arranged on the motor support 15 that are in abutment with the non-toothed outer surface of tooth belt 27 or another traction means 28 facing away from the driving gear 29 and the drive wheel 18. At least one of the guide wheels 31, 32 is arranged on the motor support 15 in an adjustable manner, e.g. by means of an elongated hole or an eccentric, in order to be able to adjust the belt pretension. They serve to push the tooth belt 27 (or the other traction means 28) against the driving gear 29 to an extent that the wrap angle along which the tooth belt 27 contacts the driving gear 29 is larger, preferably remarkably larger than 90°, e.g. larger than 130°. The length of the traction means 28 is thereby preferably not longer than the sum of the circumference of the drive wheel 18 and the circumference of the driving gear 29. However, the length of the traction means 28 is longer than the shortest embracement of driving gear 29 and drive wheel 18. Such an embracement is obtained, if the two guide wheels 31, 32 are missing and drive wheel 18 and driving gear 29 are embraced with a traction means being as short as possible. Preferably the length of the traction means 28 is longer than the sum of the shortest embracement of driving gear 29 and drive wheel 18 and half of circumference of driving gear 29.

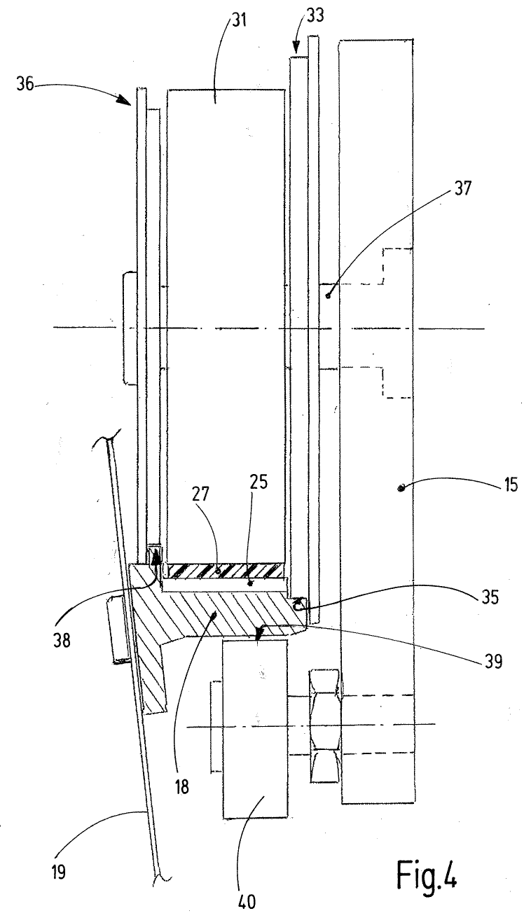

At least one, preferably two support wheels are in addition part of drive arrangement 11 that can be rotatably supported on the same axis with guide wheels 31, 32, however independent therefrom. As necessary, these support wheels can also be mounted at another location. The support wheels 33, 34 move, as apparent from FIG. 4, exemplified by support wheel 33, on a preferably approximately cylindrical tread 35 provided for this purpose formed on drive wheel 18. Preferably track 35 is thereby configured between toothing 25 or another traction means engagement surface and the motor support 15. It serves for support of motor support 15 on drive wheel 18 and is thereby particularly provided for eliminating of bending torques that could deform drive wheel 18 and therewith spokes 19. As mentioned before, support wheel 33 is preferably freely rotatable relative to guide wheel 31.

As an alternative or in addition to support wheel 33, a support wheel 36 can be provided that is supported on the same bolt 37 as guide wheel 31 and support wheel 33 in a manner being independently rotatable therefrom. A tread 38 can be assigned to support wheel 36 that is concentrically configured relative to the rotation axis of drive wheel 18, e.g. on a flange thereof projecting radially outward. The configuration of drive arrangement 11 is preferred in which at least one support wheel 33, 36 is provided on both sides of the traction means 28 or the traction means engagement surface respectively. This configuration is free of tilting torques acting on the motor support 15. For this reason the hinged joint 16 can comprise degrees of freedom in all three spatial pivot axes. The motor support is exclusively guided by drive wheel 18 with regard to the three pivot degrees of movement. Due to the displaceability of eyelet 22 on bolt 23, the hinged joint preferably comprises an additional linear movement degree of freedom parallel to the rotation axis of wheel 12 as well as driving gear 29.

As further shown in FIG. 4, the ring-shaped drive wheel 18 can comprise a tread 39 on its side located radially inward to which a support roller 40 is assigned that is rotatably supported on motor support 15. It can be adjusted such that it is in contact with tread 39 or forms a small air gap therewith. The support roller 40 can be particularly used for transmitting the counter torque or at least a part thereof from motor support 15 to the drive wheel and/or to avoid or limit tilting of motor support 15 around a rotation axis lying parallel to the rotation axis of the driving gear 29. This ensures error-free movement of tooth belt 27 also with high drive powers and concurrently low belt pretensions.

The drive arrangement 11 described so far operates as follows:

In operation the tooth belt 27 is in engagement with its toothing 26 with drive wheel 18 as well as driving gear 29 and is in contact therewith without excessive or with low pretension. Thereby guide wheels 31, 32 keep tooth belt 27 in engagement with driving gear 29 and drive wheel 18.

If the motor 11 provides drive power, driving gear 29 now transmits a drive torque on drive wheel 18 via tooth belt 27, whereby wheel 12 is subject to a drive movement. A counter torque acting thereby on motor support 15 is transferred via hinged joint 16 on frame strut 17 or another frame part immovably attached to the frame and is thus discharged. Concurrently a force is created pulling the motor support 15 toward the rotation axis of wheel 12 that is supported by means of the support wheels 33, 34 on drive wheel 18 and is thus discharged. In addition or as an alternative, this force can also be discharged by respective support wheels 36.

If motor support 15 should have the tendency to execute a minor upward and downward movement, e.g. due to an eccentricity of drive wheel 18 or due to dynamic loads, the hinged joint 16 allows this movement. However, the motor support 15 cannot approach the drive wheel, due to the support effect of support wheels 33, 34 (36) to an extent, such that the tooth belt 27 would get out of engagement with toothings 25, 30. Vice versa tooth belt 27 avoids that motor support 15 moves too far away from drive wheel 18. Such a movement is in addition blocked by support roller 40 that can then get into contact with tread 39 temporarily (or also continuously).

Preferably support wheels 33, 34 (36) comprise flanges respectively that provide a lateral guide in addition to the described radial guide of motor support 15, i.e. a guide in relation to the displacement direction defined by eyelet 22 and the bolt. In doing so, the drive arrangement 11 is particularly robust and it is ensured that a correct run of tooth belt 27 over driving gear 29 and drive wheel 18 is maintained in any operation condition. Mounting errors or misalignments affecting the function are largely excluded.

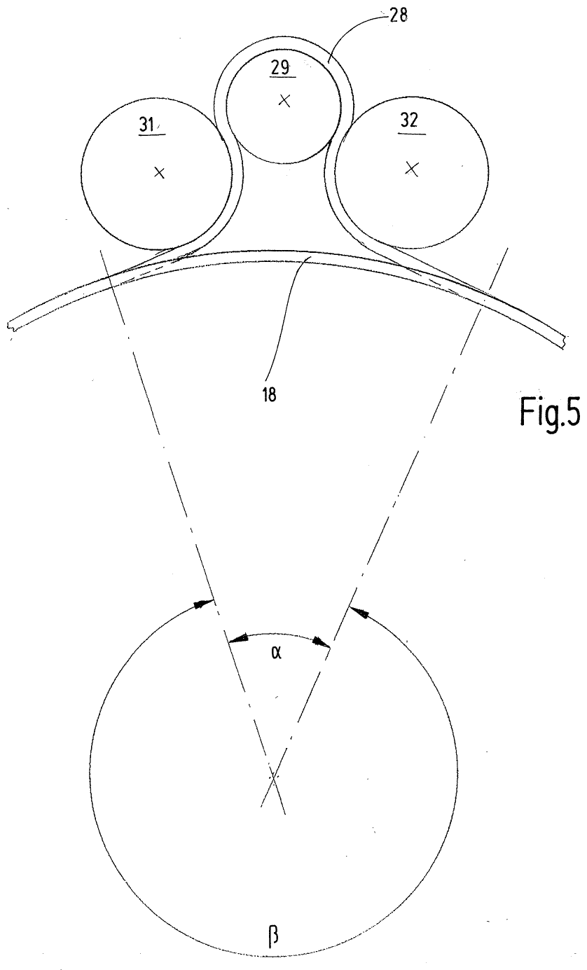

The drive arrangement basically described so far can be modified in many ways. For example, the arrangement of driving gear 29 as well as guide wheels 31, 32 schematically illustrated in FIG. 5 can be varied. For example, guide wheels 31, 32 can be positioned and the length of traction means 28 can be defined such that the wrap angle of traction means 28 on driving gear 29 becomes larger than 180°. In doing so, an angle α with which traction means 28 does not completely abut against drive wheel 18 is preferably less than 60°, further preferably less than 50°. In doing so, the wrap angle β defined by traction means 28 on drive wheel 18 is preferably larger than 310° to 320°.

In all described embodiments the traction means 28 having another form can be used instead of a tooth belt, e.g. a chain, a band, a rope or the like. If traction means 28 is a band, e.g. a steel band, the guide wheels 31, 32 can be biased by a spring tension, e.g. toward each other, in order to create a sufficiently large pressing force between traction means 28 and driving gear 29 as well as drive wheel 18 in order to avoid slip.

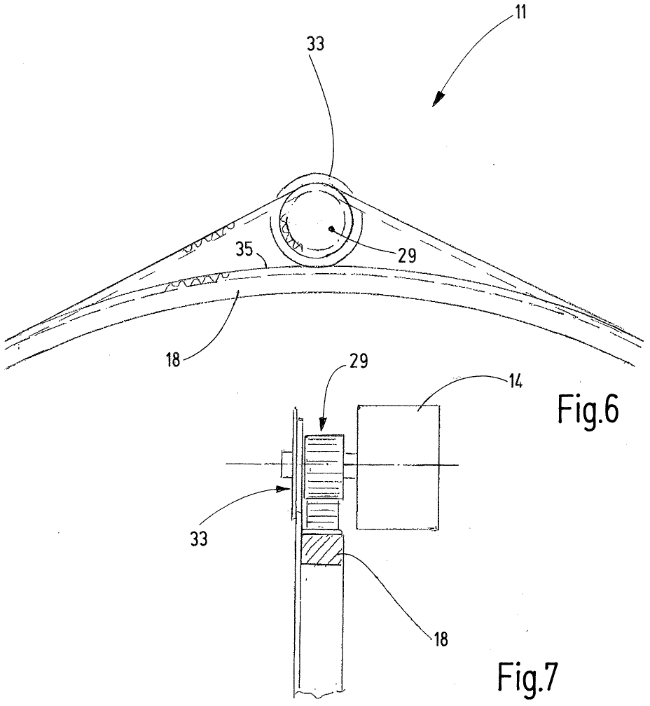

A simplified embodiment of drive arrangement 11 is illustrated in FIGS. 6 and 7. In this embodiment the guide wheels are omitted. However, the obligatory provided at least one support wheel 31 is supported concentrically to driving gear 29, however, in a manner being independent rotatable therefrom. The support wheel 31 is supported on a respective track 35 of drive wheel 18. Multiple support wheels can be provided on one or both sides of traction means 28. Apart therefrom the description to the embodiments according to FIGS. 1-5 applies accordingly.

The embodiment of drive arrangement 11 illustrated in FIGS. 6 and 7 is particularly suitable for drive arrangements with low power and/or drive arrangements in which the diameter of drive wheel 18 and driving gear 29 do not differ too much (unlike illustrated in FIGS. 6 and 7), i.e. the diameter ratio is in the range of 1:1 to 1:5.

The inventive drive arrangement 11 for vehicles comprises a motor support 15 movably supported on the vehicle having an electric motor 14 that is drivingly connected with a driving gear 29. A drive wheel 18 is assigned to the wheel 12 of the vehicle that can be configured as ring concentrically arranged to the rotation axis of wheel 12, for example. Driving gear 29 and drive wheel 18 are drivingly connected with each other by means of a traction means 28, e.g. a closed loop tooth belt 27, a closed loop chain, a closed loop band or the like. Motor support 15 comprises at least one, preferably multiple support wheels 33, 34, 36 as well as—as necessary—a support roller 40 by means of which motor support runs like a rail vehicle on the ring-shaped drive wheel 18. The radial position of motor support 15 in relation to the rotation axis of wheel 12 as well as the axial position (toward wheel 12 and away therefrom) is defined by cooperation of support wheels 33, 34, 36 and respective tracks 35, 38 as well as—as applicable—a tread 39 of drive wheel 18.

The drive arrangement described so far is remarkably quiet, thereby smoothly running and insensitive against fouling.

### LIST OF REFERENCE SIGNS

10 bicycle
11 drive arrangement
12 rear wheel
13 front wheel
14 electric motor
15 motor support
16 hinged joint
17 frame strut
18 drive wheel
19 spokes
20 strut
21 strut
22 eyelet
23 bolt
24 damping and buffer element (O-Ring)
25 toothing of drive wheel 18
26 toothing of tooth belt 27
27 tooth belt
R back side of tooth belt 27 or traction means 28
28 traction means (also chain K, rope S, band B))
29 driving gear
30 toothing of driving gear 29
31 guide wheel 32 guide wheel
33 support wheel
34 support wheel
35 track
36 support wheel
37 bolt
38 track
39 tread
40 support roller

1. A drive arrangement for a human-powered two-wheeled vehicle, comprising:
a wheel rotatably supported on the vehicle;
a drive wheel that can be attached to the wheel;
a traction means arranged in a manner embracing the drive wheel;
a motor support that is hingedly joined to a frame part of vehicle;
an electric motor attached to the motor support and being drivingly connected with a driving gear that is arranged in a manner being in engagement with traction means; and
at least one support wheel that is rotatably supported relative to motor support and that is arranged in a rolling manner on the drive wheel.

2. The drive arrangement according to claim 1, wherein a diameter of the drive wheel, a length of the traction means and a diameter of the driving are coordinated, such that a wrap angle β with which the traction means encircles the drive wheel is larger than 300°.

3. The drive arrangement according to claim 1, wherein a length of the traction means is at most as long as a sum of a circumference of the drive wheel and a circumference of the driving gear.

4. The drive arrangement according to claim 1, wherein the traction means comprises a toothing and that the drive wheel as well as the driving gear comprise a toothing respectively fitting the toothing of the traction means.

5. The drive arrangement according to claim 4, wherein the traction means is a tooth belt or a chain and that the drive wheel as well as the driving gear are respectively configured as a friction wheel.

6. The drive arrangement according to claim 1, wherein the motor support supports at least one rotatingly supported counter-support wheel that is assigned to a radially inward facing tread of the drive wheel, the drive wheel being ring-shaped.

7. The drive arrangement according to claim 1, wherein at least one guide wheel is assigned to the traction means and the at least one guide wheel is in abutment with a back side of the traction means.

8. The drive arrangement according to claim 7, wherein the at least one guide wheel is freely rotatingly supported on the motor support.

9. The drive arrangement according to claim 1, wherein at least one track for the at least one support wheel is formed on the drive wheel.

10. The drive arrangement according to claim 9, wherein the at least one track is a cylinder surface.

11. The drive arrangement according to claim 9, wherein the at least one track is arranged next to a force-transmitting surface.

12. The drive arrangement according to claim 11, wherein the at least one tracks is a pair of tracks for support wheels that are arranged on both sides of the force-transmitting surface.

13. The drive arrangement according to claim 7, wherein the at least one guide wheel and the at least one support wheel are arranged coaxially to one another.

14. The drive arrangement according to claim 13, wherein the at least one guide wheel and the at least one support wheel are rotatingly supported independent from one another.

15. A vehicle having a drive arrangement according to claim 1.

16. The drive arrangement according to claim 4, wherein the traction means is configured as rope or a band and that the drive wheel as well as the driving gear are respectively configured as a friction wheel.

17. The drive arrangement according to claim 11, wherein toothing is assigned to the force-transmitting surface.

18. The drive arrangement according to claim 2, wherein a length of the traction means is at most as long as a sum of a circumference of the drive wheel and a circumference of the driving gear.

19. The drive arrangement according to claim 18, wherein the traction means comprises a toothing and that the drive wheel as well as the driving gear comprise a toothing respectively fitting the toothing of the traction means.

20. The drive arrangement according to claim 19, wherein the traction means is a tooth belt or a chain and that the drive wheel as well as the driving gear are respectively configured as a friction wheel.
